(19) United States
(12) Patent Application Publication
(10) Pub. No.: US 2013/0168264 A1
(43) Pub. Date: Jul. 4, 2013

(54) Method for Measuring HF Content in Lithium Secondary Battery Electrolyte and Analytical Reagent Composition Used in the Same

(71) Applicant: Soulbrain Co., Ltd., Seongnam-si (KR)

(72) Inventor: Suk Hwan Youn, Gongju-si (KR)

(73) Assignee: SOULBRAIN CO., LTD., Seongnam-si (KR)

(21) Appl. No.: 13/721,874

(22) Filed: Dec. 20, 2012

(30) Foreign Application Priority Data
Dec. 28, 2011 (KR) 10-2011-0144431
Nov. 6, 2012 (KR) 10-2012-0124790

(51) Int. Cl. G01N 27/416

(52) U.S. Cl. CPC G01N 27/4166
USPC 205/778.5; 205/780.5

(57) ABSTRACT

Provided are a method for measuring hydrofluoric acid content in a lithium secondary battery electrolyte and an analytical reagent composition used in the same.

### CROSS-REFERENCE TO RELATED APPLICATIONS

This application claims priority under 35 U.S.C. §119 to Korean Patent Application No. 10-2011-0144431, filed on Dec. 28, 2011, No. 10-2012-0124790, filed on Nov. 6, 2012, in the Korean Intellectual Property Office, the disclosure of which is incorporated herein by reference in its entirety.

### TECHNICAL FIELD

The following disclosure relates to a method for measuring hydrofluoric acid (HF) content in a lithium secondary battery electrolyte and an analytical reagent composition used in the same.

### BACKGROUND

With the recent increase in the use of a lithium secondary battery in a mobile phone, a hybrid electric car, or the like, a lithium secondary battery electrolyte has been actively studied and developed.

With respect to a currently and widely used lithium secondary battery electrolyte, a lithium salt such as LiPF₆, lithium bis(oxaleto)borate (LiBOB), or the like, is dissolved in a carbonate based solvent such as ethylene carbonate, dimethyl carbonate, ethylmethyl carbonate, or the like. This is shown in Korean Patent Laid-Open Publication Nos. 10-2008-0000595 and 10-2011-0058507 and Korean Patent Registration No. 10-0585947.

It is important to maintain the quality of this lithium secondary battery electrolyte to be uniform, and contents of moisture, hydrofluoric acid (HF), and negative ions are the most important factors for analysis. The reason is that, even though trace of moisture and negative ions (Cl—, SO₄, or the like) are contained in an electrolyte, they react with a lithium salt such as LiPF₆ or LiBF₄ of electrolytic components of the lithium secondary battery to produce vapor or free-state HF and HCl, which cause the battery to explode. Therefore, the electrolyte is required to contain HF and moisture in several ppm or less. Thus, the quality test is performed by measuring the moisture content and HF content in the lithium secondary battery electrolyte.

However, in the case where lithium bis(oxaleto)borate called LiBOB is contained in the lithium secondary battery electrolyte, it is difficult to measure the HF content by using a titrating analysis method known in the related art.

According to the acid-base titration analysis method known in the related art, a lithium secondary battery electrolyte diluted with deionized water is used as a sample, and a mixture where a basic material such as NaOH or the like is mixed with deionized water is used as a titrating reagent. The end point is obtained by measuring the time at which the color of an indicator is changed, which is then used to calculate the acid content. At this time, the water contained in the titrating reagent and the water used in diluting the electrolyte react with LiBOB to generate boric acid. For this reason, the concentration of boric acid is together measured at the same time when the concentration of HF is measured, and thus, it is impossible to measure the content of only HF.

In order to suppress the generation of boric acid, the sample may be immersed in an ice bath to maintain the temperature of the sample at about 4° C. However, regardless of the lowered temperature, boric acid is generated due to the reaction of water used in the analytic reagent, and thus it is difficult to measure accurate HF content. Moreover, it is more difficult to measure the HF content in the lithium secondary battery electrolyte since quality of the electrolyte needs to be controlled by the ppm unit.

A method for measuring the HF content according to the related art is shown in Korean Patent Registration No. 10-0923860. However, this patent is directed to a method for selectively analyzing the HF concentration in a mixture acid solution containing HF and this measurement is possible within the solution of which the HF content is fixed.

However, in the method of using the lithium secondary battery electrolyte, LiBOB of the electrolyte reacts with moisture in a titrating reagent, and simultaneously reacts with moisture in the air as time goes on, resulting in continuously increasing the boric acid content. In this case, it is impossible to measure the HF content by the method shown in Korean Patent Registration No. 10-0923860.

Therefore, in order to measure the content of acid component in the lithium secondary battery electrolyte containing LiBOB, an analysis method for preventing generation of boric acid needs to be developed.

### RELATED ART DOCUMENTS

### Patent Documents

(Patent Document 1) Korean Patent Laid-Open Publication No. 10-2008-0000595 (2008 Jan. 2)
(Patent Document 2) Korean Patent Laid-Open Publication No. 10-2011-0058507 (2011 Jun. 1)
(Patent Document 3) Korean Patent No. 10-0585947 (2006 May 25)
(Patent Document 4) Korean Registration Patent No. 10-0923860 (2009 Oct. 20))

### SUMMARY

An embodiment of the present invention is directed to providing a new analysis method for measuring hydrofluoric acid (HF) content in a lithium secondary battery electrolyte and an analytical reagent composition used in the same.

Another embodiment of the present invention is directed to providing a new analysis method with excellent precision and accuracy, by preventing the generation of boric acid in a lithium secondary battery electrolyte containing LiBOB to thereby allow only HF content in the electrolyte to be substantially measured.

Still another embodiment of the present invention is directed to providing an analytical reagent composition for measuring hydrofluoric acid (HF) content in a lithium secondary battery electrolyte.

The present invention relates to a method for measuring hydrofluoric acid (HF) content in a lithium secondary battery electrolyte using acid-base titration, and an analytical reagent composition used in the same.

In one general aspect, a method for measuring HF content in a lithium secondary battery electrolyte of the present invention includes:

a) preparing a sample by dissolving a lithium secondary battery electrolyte in a non-aqueous solvent capable of dissolving a lithium secondary battery electrolyte therein;

b) preparing a titration liquid by dissolving an amine compound in a non-aqueous solvent capable of dissolving a lithium secondary battery electrolyte therein; and

c) obtaining an end point by dropping the titration liquid in the stage b) into the sample in the stage a).

According to the present invention, all the stages from preparing the sample to titrating are conducted in a closed space where the moisture content is controlled to be 10 ppm or less, so that reactions with moisture in the air can be prevented, and thus, a measurement method exhibiting excellent reproducibility and precision can be provided.

That is, in the case where the measurement is performed in a general environment, reactions with moisture in the air occur during a sampling procedure where a sample is weighted in order to perform titration, and thus, the HF concentration may be further increased. Therefore, it is important to suppress contamination by atmospheric environment and maintain uniform measurement environment. Therefore, all the stages, such as taking a sample, diluting the sample, preparing a titration liquid, titration-analyzing, and the like, are preferably conducted in a glove box where temperature and moisture content are uniformly controlled.

More preferably, overall procedures from taking a sample to a measuring process are preferably conducted by connecting a reactor producing the lithium secondary battery electrolyte to an inner portion of the glove box through a tube.

In another general aspect, an analytical reagent composition for measuring HF content in a lithium secondary battery electrolyte includes: a first solution containing a non-aqueous solvent for diluting a lithium secondary battery electrolyte; and a second solution as a titration liquid, the second solution being prepared by dissolving an amine compound in a non-aqueous solvent, wherein the non-aqueous solvent of each of the first and second solutions is capable of dissolving the lithium secondary battery electrolyte therein.

The analytical reagent composition of the present invention minimizes the reaction with moisture, and is characterized by not containing moisture or alcohol and employing a non-aqueous solvent capable of dissolving a lithium secondary battery electrolyte therein.

### DETAILED DESCRIPTION OF EMBODIMENTS

Hereinafter, the present invention will be described in more detail.

First, the present invention is directed to a method for measuring hydrofluoric acid (HF) content in a lithium secondary battery electrolyte by using acid-base titration, the method includes:

a) preparing a sample by dissolving a lithium secondary battery electrolyte in a non-aqueous solvent capable of dissolving a lithium secondary battery electrolyte therein;

b) preparing a titration liquid by dissolving an amine compound in a non-aqueous solvent capable of dissolving a lithium secondary battery electrolyte therein; and

c) obtaining an end point by dropping the titration liquid in the stage b) into the sample in the stage a).

Here, the stages a) to c) are conducted while the moisture content is maintained at 10 ppm or less.

More specifically, the stages a) to c) are preferably conducted in a closed space where the moisture is controlled to be 10 ppm or less, so that reaction with moisture in the air does not occur.

In the present invention, as the lithium secondary battery electrolyte, any electrolyte that can contain a lithium salt, such as LiPF₆, LiBF₄, or the like, may be used without limitation. The present invention may be useful in measuring HF content in an electrolyte. In particular, the present invention may be useful in measuring the HF content in the lithium secondary battery electrolyte, containing a lithium salt such as LiPF₆, LiBF₄, or the like, and lithium bis(oxaleto)borate (LiBOB). That is, as the lithium bis(oxaleto)borate (LiBOB) reacts with moisture or water to generate boric acid, it is difficult to accurately measure the content of HF contained in the electrolyte. However, the measurement method of the present invention allows the HF content to be accurately measured.

The non-aqueous solvent does not contain moisture and dissolves the lithium secondary battery electrolyte therein. A general non-aqueous solvent that can be used in the lithium secondary battery electrolyte may be preferably used. Specifically, for example, a carbonate based solvent selected from the group consisting of cyclic carbonate, branched carbonate, and a combination thereof may be preferably used.

More specifically, the cyclic carbonate may be selected from the group consisting of any one or two or more combinations selected from ethylene carbonate, butylene carbonate, propylene carbonate, and γ-butyrolactone, and the branched carbonate may be selected from the group consisting of any one or two or more combinations selected from dimethyl carbonate, methyl carbonate, and diethyl carbonate, but they are not limited thereto.

In the present invention, it is preferable to use a non-aqueous solvent of which the moisture content is controlled to be 1 ppm or less.

In addition, according to the present invention, the stages a) to c) are conducted in a closed space where the moisture content is controlled to be 10 ppm or less, to thereby prevent reaction with water in the air, so that there can be provided a measurement method exhibiting excellent reproducibility and precision. More specifically, the stages a) to c) are preferably conducted in a glove box where the moisture content is controlled to be 10 ppm or less.

In the stage a) of the present invention, the sample is prepared by dissolving the lithium secondary battery electrolyte in the non-aqueous solvent. Here, the mixing ratio thereof does not influence the reaction, and thus is not limited, but suitable is 50˜70 g of the non-aqueous solvent per 10 g of the sample.

In addition, in the stage a), propylene carbonate is preferably used as the non-aqueous solvent since the propylene carbonate can dissolve most of additives and compositions contained in the lithium secondary battery electrolyte. However, without limitation thereto, a carbonate based solvent selected from the group consisting of the cyclic carbonate, the branched carbonate, and a combination thereof may be used.

In the stage b) of the present invention, the titration liquid is prepared by dissolving an amine compound in a non-aqueous solvent. Here, the amine compound is preferably dissolved in the non-aqueous solvent in preferably 0.005˜0.02 mol, and more preferably 0.01˜0.015 mol per 1 L of the non-aqueous solvent. The above range is suitable for measuring a very small amount of HF concentration, and leads to a decrease in analytical error.

The amine compound may be an aliphatic amine compound selected from the group consisting of triethyl amine, tripropyl amine, N,N-dimethylbutyl amine, N-methylbutyl amine, tributyl amine, N,N-dimethylhexyl amine, N,N-dimethyloctyl amine, N,N-dimethylundecyl amine, and N,N-dimethyldodecyl amine, or an aromatic amine compound selected from the group consisting of N,N-dimethylbenzyl amine, N-methyldiphentylethyl amine, tribenzyl amine, 3-(dibenzyl amino)-1-propanol, and N-ethyl-3,3′-diphenyldipropyl amine, and N,N-dimethyl amino ethyl benzoate, but is not limited thereto.

In the stage b), it is preferable to use ethylmethyl carbonate as a non-aqueous solvent. However, without limitation thereto, a carbonate based solvent selected from the group consisting of the cyclic carbonate, the branched carbonate, and a combination thereof may be used.

In addition, as necessary, the titration liquid may further contain an indicator, and any indicator that can be used in acid-base titration may be used without limitation. Specifically, for example, methyl orange or the like may be used.

In the stage c) of the present invention, titrating is performed. Here, the titrating may be conducted by a potential difference titration method. An apparatus used here may be 789Mdel by Methrohm Company or the like.

In addition, in the potential difference titration method according to the present invention, in order to obtain accurate and reproducible analysis results, it is preferable that the titration rate of the titration liquid is 1 to 5 ml/min, the potential change is 40 to 60 mV/min, and the stabilizing time is 10 to 40 seconds. In order to improve the measurement precision and reproducibility, the titration rate is preferably minimized, but 1 to 5 ml/min is suitable considering the measurement time. The moment the titration liquid is dispensed into an analytical solution, a rapid potential change occurs. If the potential change range is set to be high, it is difficult to accurately measure the equivalent point. On the contrary to this, if the potential change range is set too low, the analyzing takes a long time, and thus electrodes may be unstable. Therefore, the potential change is preferably maintained at 40 to 60 mV/min. The stabilization time is referred to the time while, after being dispensed, the titration liquid is stabilized by the rapid potential change and then maintained. The stabilizing time is preferably set to be 10 to 40 seconds to improve the measurement precision and reproducibility.

The HF content may be obtained by Equation 1 below.

HF content (ppm)=((Amine compound consumption (ml)×N of amine compound×2.001)/(Weight of sample (g))×10⁴ [Equation 1]

In Equation 1, the amine compound consumption means the consumption dispensed at the time of titration, and the dispensing is conducted by the ml unit. The N of amine compound is a normal factor of the titration liquid, and the unit thereof is mol/L. The constant 2.001 corresponds to a molecular weight value of HF, which is deduced at the time of conversion into % concentration when the titration liquid is dispensed by the ml unit. The constant 10⁴ is an equivalent factor which converts the % unit into the ppm unit.

The end point means a value measured by using a potential difference (mV) measurement instrument. In the case of Auto-Titrator, since a potentiometric titrator is used, the end point means a point at which an inflection point is shown at the time of first derivation of a potential difference (mV)-titration volume (ml) graph.

Hereinafter, the present invention will be described in more detail with reference to the embodiments. However, the following examples are merely examples of the present invention, and the scope of the present invention is not limited to the following examples.

### Example 1

Experiments below were carried out in a glove box where the moisture content was controlled to be 10 ppm or less. Each sample was controlled to have a moisture content of 1 ppm or less, and then used in the experiment.

Each sample was prepared by dissolving 1 g of lithium bis(oxaleto)borate (LiBOB) in 0.1 L of a propylene carbonate solvent.

A titration liquid was prepared by dissolving trimethyl amine in ethylmethyl carbonate at 0.01 mol/L, and 0.1 g of a methyl orange indicator was added thereto.

As a potentiometric titrator used for potential difference titration, 798 Basic Titrino by Metrohm Company was used. As an electrode, Solvotrode (6.0229.100 LL) by Metrohm Company was used, and as an electrolyte, an ethanol solution having LiCl dissolved therein was used.

0.1 g of amidosulfuric acid (HOSO₂NH₂), which is a standard material for quantitative analysis by JUNSEI Company, was taken, and the potential difference titration using 0.01 mol/L of trimethyl amine was performed by a potentiometric titrator.

Factor=(Triethyl amine consumption (ml)×0.09709×0.9991(Purity of Amidosulfuric acid)/weight of sample (g)

Here, the amidosulfuric acid (HOSO₂NH₂) had a molecular weight of 97.095 and a purity of 99.91%.

10 g of the sample fills 100 mL of a polyethylene (PE) beaker, followed by stirring.

The Solvotrode electrodes were immersed in the sample, and then the potential difference was measured by using the potentiometric titrator while the titrating with the titration liquid was performed. Here, the titration rate was 3 ml/min, the signal drift was 50 mV/min, and the stabilizing time was 25 seconds.

The HF content was measured, and tabulated in Table 1.

### Example 2

Experiments below were carried out in a glove box where the moisture content was controlled to be 10 ppm or less. Each sample was controlled to have a moisture content of 1 ppm or less, and then used in the experiment.

As an electrolyte for a secondary battery, a composition containing 31.50 wt % of ethylene carbonate, 15.50 wt % of diethyl carbonate, 40.00 wt % of ethylmethyl carbonate, 12.80 wt % of LiPF₆, and 0.2 wt % of LiBF₄ was prepared.

The same method as Example 1 was conducted except that the sample was prepared by dissolving 10 g of the electrolyte in about 70 g of a propylene carbonate solvent.

### Example 3

Experiments below were carried out in a glove box where the moisture content was controlled to be 10 ppm or less. Each sample was controlled to have a moisture content of 1 ppm or less, and then used in the experiment.

As a secondary battery electrolyte, a composition containing 31.30 wt % of ethylene carbonate, 15.50 wt % of diethyl carbonate, 40.00 wt % of ethylmethyl carbonate, 12.80 wt % of LiPF₆, 0.2 wt % of LiBF₄, and 0.2 wt % of LiBOB was prepared.

The same method as Example 1 was conducted except that the sample was prepared by dissolving 10 g of the electrolyte in 70 g of a propylene carbonate solvent.

### Comparative Example 1

The experiment below was conducted in a general room having a temperature of 25° C. and a humidity of 17%.

A sample was prepared by dissolving 1 g of lithium bis(oxaleto)borate (LiBOB) in 0.1 L of water.

A titration liquid was prepared by dissolving NaOH in deionized water at 0.01 mol/L, and 0.1 g of a methyl orange indicator was added thereto.

As a potentiometric titrator used in potential difference titration, 798 Basic Titrino by Metrohm Company was used. As an electrode, Solvotrode (6.0229.100 LL) by Metrohm Company was used, and as an electrolyte, an ethanol solution having LiCl dissolved therein was used.

The factor is the same as that of Example 1.

10 g of the sample fills 100 mL of a polyethylene (PE) beaker, followed by stirring.

The Solvotrode electrodes were immersed in the sample, and then the potential difference was measured by using the potentiometric titrator while the titrating with the titration liquid was performed. Here, the titration rate was 3 ml/min, the signal drift was 50 mV/min, and the stabilizing time was 25 seconds.

As a result, as time goes on, the acid content is continuously increased, and thus, it is impossible to measure accurate HF content. The minimum content is shown in Table 1.

### Comparative Example 2

The experiment below was conducted in a general room having a temperature of 25° C. and a humidity of 17%.

As an electrolyte for a secondary battery, a composition containing 31.50 wt % of ethylene carbonate, 15.50 wt % of diethyl carbonate, 40.00 wt % of ethylmethyl carbonate, 12.80 wt % of LiPF₆, and 0.2 wt % of LiBF₄ was prepared.

The same method as Example 1 was conducted except that the sample was prepared by dissolving 10 g of the electrolyte in 70 g of water.

As a result, as time goes on, the acid content is continuously increased, and thus, it is impossible to measure accurate HF content. The minimum content is shown in Table 1.

### Comparative Example 3

The experiment below was conducted in a general room having a temperature of 25° C. and a humidity of 17%.

As a secondary battery electrolyte, a composition containing 31.30 wt % of ethylene carbonate, 15.50 wt % of diethyl carbonate, 40.00 wt % of ethylmethyl carbonate, 12.80 wt % of LiPF₆, 0.2 wt % of LiBF₄, and 0.2 wt % of LiBOB was prepared.

The same method as Example 1 was conducted except that the sample was prepared by dissolving 0.1 g of the electrolyte in 70 g of water.

As a result, as time goes on, the acid content is continuously increased, and thus, it is impossible to measure accurate HF content. The minimum content is shown in Table 1.

TABLE 1

| | | Comparative | |
|---|---|---|---|
| | Example | Example | |
| | (Unit: ppm) | (Unit: ppm) | Note |
| 1 | 212 | 2614 | LiBOB raw material |
| 2 | 20 | 65 | Secondary battery electrolyte |
| | | | (Before addition of LiBOB) |
| 3 | 21 | 120 | Secondary battery electrolyte |
| | | | (After addition of LiBOB) |

As shown in Table 1 above, in the examples of the present invention, the HF content before and after addition of LiBOB can be accurately measured. However, it can be seen that, in the comparative examples 1 to 3, the acid content is continuously increased as time goes on, which fails to measure accurate acid content, and the minimum content thereof was higher as compared with the examples.

As set forth above, the measurement method according to the present invention allows accurate measurement of HF content in a lithium secondary battery electrolyte susceptible to moisture, and provides high degree of precision and reproducibility therefor.

Further, the analytical reagent composition of the present invention can suppress the generation of byproducts of the lithium secondary battery electrolyte susceptible to moisture, and thus allows accurate measurement of HF content in the lithium secondary battery electrolyte.

What is claimed is:

1. A method for measuring hydrofluoric acid (HF) content in a lithium secondary battery electrolyte by using acid-base titration, the method comprising:
a) preparing a sample by dissolving a lithium secondary battery electrolyte in a non-aqueous solvent capable of dissolving a lithium secondary battery electrolyte therein;
b) preparing a titration liquid by dissolving an amine compound in a non-aqueous solvent capable of dissolving a lithium secondary battery electrolyte therein; and
c) obtaining an end point by dropping the titration liquid in the stage b) into the sample in the stage a).

2. The method of claim 1, wherein the non-aqueous solvent is selected from the group consisting of cyclic carbonate, branched carbonate, and a combination thereof.

3. The method of claim 2, wherein the non-aqueous solvent is controlled to have a moisture content of 1 ppm or less.

4. The method of claim 2, wherein the cyclic carbonate is selected from the group consisting of any one or two or more combinations selected from ethylene carbonate, butylene carbonate, propylene carbonate, and γ-butyrolactone, and the branched carbonate is selected from the group consisting of any one or two or more combinations selected from dimethyl carbonate, methyl carbonate, and diethyl carbonate.

5. The method of claim 1, wherein the stages a) to c) are conducted within a glove box where the moisture content is controlled to be 10 ppm or less.

6. The method of claim 1, wherein the titration liquid in the stage b) further contains an indicator.

7. The method of claim 1, wherein the lithium secondary battery electrolyte contains lithium bis(oxalate)borate.

8. The method of claim 1, wherein the stage c) is conducted by potential difference titration.

9. An analytical reagent composition for measuring an HF content in a lithium secondary battery electrolyte, the analytical reagent composition comprising:
a first solution containing a non-aqueous solvent for diluting a lithium secondary battery electrolyte; and
a second solution as a titration liquid, the second solution being prepared by dissolving an amine compound in a non-aqueous solvent,
wherein the non-aqueous solvent of each of the first and second solutions is capable of dissolving the lithium secondary battery electrolyte therein.

10. The analytical reagent composition of claim 9, wherein the lithium secondary battery electrolyte contains lithium bis(oxalate)borate.

11. The analytical reagent composition of claim 9, wherein the non-aqueous solvent is controlled to have a moisture content of 1 ppm or less.

12. The analytical reagent composition of claim 11, wherein the non-aqueous solvent is selected from the group consisting of cyclic carbonate, branched carbonate, and a combination thereof.

13. The analytical reagent composition of claim 12, wherein the cyclic carbonate is selected from the group consisting of any one or two or more combinations selected from ethylene carbonate, butylene carbonate, propylene carbonate, and γ-butyrolactone, and the branched carbonate is selected from the group consisting of any one or two or more combinations selected from dimethyl carbonate, methyl carbonate, and diethyl carbonate.

14. The analytical reagent composition of claim 9, wherein the titration liquid further contains an indicator.

15. The analytical reagent composition of claim 9, wherein it is used for potential difference titration.
